(19) United States
(12) Patent Application Publication
(10) Pub. No.: US 2008/0285077 A1
(43) Pub. Date: Nov. 20, 2008

(54) Server and System for Printing Photo Sheet Utilizing Network for Sales Promotion of Disposable Baby Commodities

(76) Inventors: Yumika Fuchi, Kobe (JP); Mai Nakamura, Setagaya-ku (JP)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/123,054

(22) Filed: May 19, 2008

Related U.S. Application Data
(60) Provisional application No. 60/930,551, filed on May 17, 2007.

(51) Int. Cl. G06K 15/00

(52) U.S. Cl. 358/1.15

(57) ABSTRACT

A server for printing a photo sheet. The server is connected with a client terminal and a printing apparatus via a network. The server includes one or more receivers for receiving data related to customers and/or children of customers. One or more receiving periods are configured based on the information. Information is stored in one or more databases. The server may receive data, configure a detection period, and print out images based on the information.

### CROSS REFERENCE TO RELATED APPLICATION

This application claims the benefit of U.S. Provisional Application No. 60/930,551, filed May 17, 2007, which is incorporated herein by reference.

### FIELD OF THE INVENTION

The present invention related to a server and a system for printing a photo sheet of a baby's image data. More particularly, the present invention relates to a server and a system which utilize network for printing a photo sheet, wherein the printing is carried out based on the purchase record of disposable baby commodities. The present invention is useful for sales promotion of disposable baby commodities.

### BACKGROUND OF THE INVENTION

Nowadays with the development of Internet, there are a lot of systems for printing photo sheets which utilize network. In such a system, a customer accesses a server of the system, uploads photographic data to the server and orders printing via network. The printed photo sheets are delivered to the place, for example, home and office which the customer designated. The customer receives the photo sheets and stores them in a photographic album.

Also, there are a lot of systems for printing photo books which utilize network. The photo books are also delivered to the place which the customer designated. As a photo book comprises a plurality of photographs, the customer need not store each photograph in a photographic album. Furthermore, the customer may modify the design of the photo books by adding literal commentary information and by changing the background art.

In the meanwhile, there are a lot of means for sales promotion of disposable baby commodities. Because babies grow fast, the disposable baby commodities are usually used in a limited period but repeatedly. Therefore, it is essential for the manufacturers to promote the customers to purchase their commodities continually. The means for sales promotion of disposable baby commodities include price reduction, adding bonus articles that reduce the price per item, and the like. The means for sales promotion of disposable baby commodities also include giving free gifts, wherein the customer accumulates purchase marks of the disposable baby commodities and exchange the points with free gifts. As the customer purchases more disposable baby commodities, the customer may get more free gifts based on the purchase marks.

However, a system for printing photo sheets or photo books which utilizes network has not been used for sales promotion of disposable baby commodities. Moreover, there has been no system for printing photo books which utilizes network that is used for sales promotion associated with the purchase record.

Accordingly, there has been a need for a server and a system for printing a photo sheet which utilize network for sales promotion of disposable baby commodities. Particularly, there has been a need for a server and a system for printing a photo sheet which utilize network for sales promotion of disposable baby commodities which is associated with the purchase record.

### SUMMARY OF THE INVENTION

The present invention relates to a server for printing a photo sheet which utilizes network. The server is connected with a client terminal and print apparatus via network. The server comprises a receiving means for receiving customer information. The server comprises a receiving means for receiving baby's birthday information. The server comprises a receiving means for receiving a baby's image data. The server comprises a configuring means for configuring at least one receiving period based on the baby's birthday information, wherein the receiving period is for receiving the baby's image data. The server comprises a storing means for storing the baby's image data corresponding to the receiving period for each customer. The server comprises a receiving means for receiving a purchase record. The server comprises a configuring means for configuring a detection period based on the baby's birthday information. The server comprises a detecting means for detecting the purchase record within the detection period. The server comprises an enabling means for enabling the print apparatus, based on the detection of the purchase record within the detection period, to print out the baby's image data corresponding to the receiving period after the receiving period has expired.

The present invention also relates to a system for printing a photo sheet which utilizes network. The system comprises a server, a client terminal and print apparatus which are connected to one another via network. The client terminal comprises a transmitting means for transmitting customer information to the server. The client terminal comprises a transmitting means for transmitting baby's birthday information to the server. The client terminal comprises a transmitting means for transmitting a baby's image data to the server. The server comprises a receiving means for receiving customer information. The server comprises a receiving means for receiving baby's birthday information. The server comprises a receiving means for receiving a baby's image data. The server comprises a configuring means for configuring at least one receiving period based on the baby's birthday information, the receiving period being for receiving the baby's image data. The server comprises a storing means for storing the baby's image data corresponding to the receiving period for each customer. The server comprises a receiving means for receiving a purchase record of disposable baby commodities. The server comprises a configuring means for configuring a detection period based on the baby's birthday information. The server comprises a detecting means for detecting the purchase record within the detection period. The server comprises an enabling means for enabling the print apparatus, based on the detection of the purchase record within the detection period, to print out the baby's image data corresponding to the receiving period for each customer after the receiving period has expired. The print apparatus comprises a receiving means for receiving the baby's image data from the server. The print apparatus comprises a printing means for printing out the baby's image data transmitted from the server.

### BRIEF DESCRIPTION OF THE DRAWINGS

While the specification concludes with claims which particularly points out and distinctly claim the invention, it is believed that the present invention will be better understood from the following description of preferred embodiments taken in conjunction with the accompanying drawings, in which like reference numerals identify identical elements and wherein:

FIG. 1 illustrates an overall system of the present invention,

FIG. 2 illustrates a constitution of the client terminal,

FIG. 3 illustrates a constitution of the server,

FIG. 4 illustrates a constitution of the print apparatus,

FIG. 5 illustrates an example of the registration form,

FIG. 6 illustrates an example of login screen,

FIG. 7 illustrates a birthday input form,

FIG. 8 illustrates a time table including a receiving period and a detection period,

FIG. 9 illustrates a time table including a plurality of receiving periods and a plurality of detection periods,

FIG. 10 illustrates a flow of the movement of the information among the client terminal, the server and the print apparatus,

FIG. 11 illustrates an excerpt of the time table illustrated in FIG. 9,

FIG. 12 illustrates an exemplary photo sheet provided by the server of the present invention, and

FIG. 13 illustrates an exemplary photo book comprising the photo sheets prepared by the server of the present invention.

### DETAILED DESCRIPTION OF THE INVENTION

Herein, the terms “comprise”, “include” and “contain” mean that other element(s) and step(s) which do not affect the end result can be added. These terms encompass the terms “consisting of” and “consisting essentially of”.

The customer purchases disposable baby commodities which include sales promotion information. The package of the disposable baby commodities may comprise a URL indicating the web site so that the customer may be able to access the manufacturer's server to obtain the details of sales promotion information. The sales promotion includes printing a photo sheet of a baby's image data and additionally may include delivering the photo sheet to a customer based on the fact that the customer purchased the disposable baby commodities designated for the sales promotion. The disposable baby commodities may include disposable commodities which can be bought, sold and used for babies, toddlers or small children. Examples of the disposable baby commodities include diapers, wipes, training pants, feeding bottles, baby's toys, and the like, but not limited to them.

When the customer accesses the server via network from a client terminal, the server responds to the access and the server transmits input screen information to the client terminal. The customer enters required information via the client terminal and registers at the server. The customer may be given a customer ID and a password by the registration. Then the customer is able to log in the server with the customer ID and the password from then on and is able to upload the baby's image data within the receiving period for the server to receive the baby's image data. The customer sends the baby's birthday information to the server via the client terminal. The baby's birthday information is the basis for configuring the receiving period for receiving the baby's image data and for configuring the detection period for detecting the purchase record of the disposable baby's commodities. The customer may upload a baby's image data to the server, and a receiver of the server receives it. Then the baby's image data is stored in a database of the server. Separately, the customer submits the purchase record of the disposable baby commodities to the server in order to receive the photo sheet. After the customer sends the purchase record to the server and the detector of the server detects the purchase record within the detection period, the enabler of the server enables the print apparatus to print out the baby's image data corresponding to the receiving period and a printed photo sheet comprising the baby's image data is printed and delivered to the customer. Thus, the system provides the customer with a baby's photo sheet based on the purchase record to encourage the customer to purchase the disposable baby commodities. The system is useful for sales promotion of the disposable baby commodities.

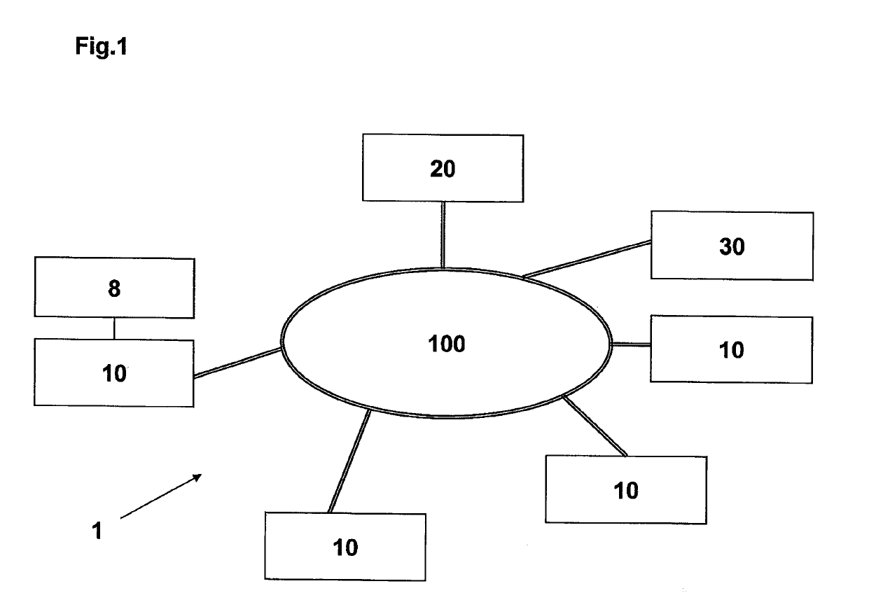

FIG. 1 illustrates an overall system of the present invention. The system 1 comprises a client terminal 10, a server 20 and print apparatus 30 which are connected via network 100. A customer 8 accesses the server 20 from the client terminal 10. The network 100 may include a plurality of computers or other devices connected through a communication line. The network 100 includes a Local Area Network (LAN), the Internet and the like. Variations on the network 100 include a wired network, a Wireless Access Protocol (WAP) network, a mobile telephone network and the like.

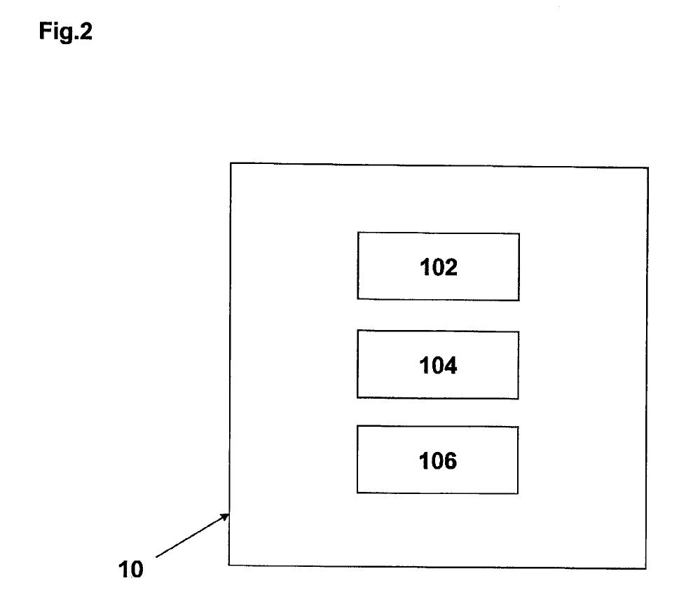

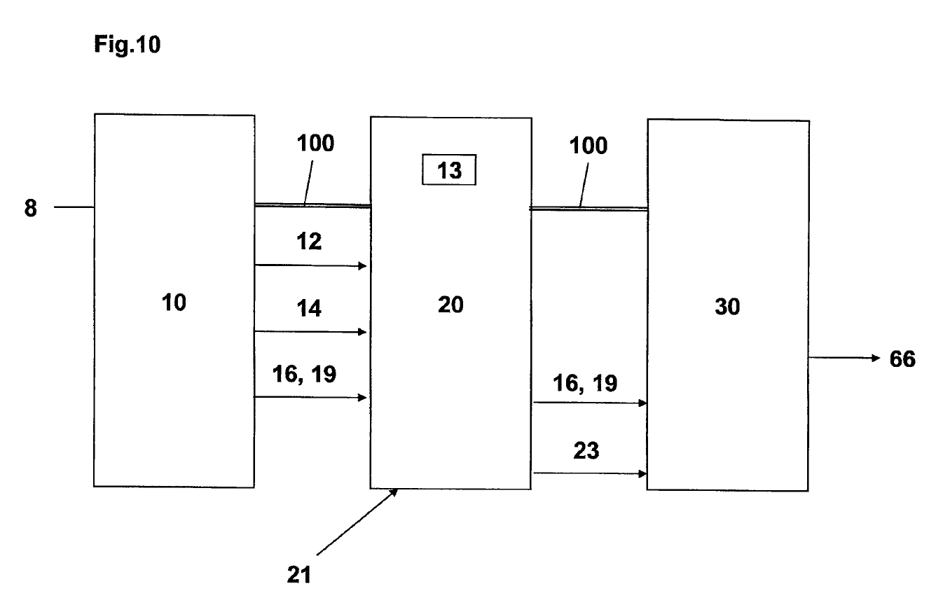

FIG. 2 illustrates a constitution of the client terminal 10. The client terminal 10 is a device from which the customer 8 accesses the server 20 via network 100. Examples of the client terminal 10 may include a personal computer (e.g., a desktop computer, a laptop computer and a portable computer), a mobile phone, a wristwatch, a personal digital assistant (PDA), and the like. The client terminal 10 may comprise an input device (e.g., a keyboard, a touch panel, a mouse pointer, a handwritten character recognition system) for entering data or a request to be transmitted to the server 20, and an output device (e.g., a printer, a display, a speaker) for outputting data transmitted from the server 20 to the client terminal 10. The client terminal 10 comprises a customer information transmitter 102 for transmitting customer information 14 (refer to FIG. 10) to the server 20. The client terminal 10 also comprises a birthday transmitter 104 for transmitting baby's birthday information 14 to the server 20. The client terminal 10 comprises an image transmitter 106 for transmitting a baby's image data 16 (refer to FIG. 10) to the server 20. The “baby's image data” may be a digital image data. The baby's image data 16 may include, but not limited to, an image data in which the baby appears, an image data in which a family member of the baby appears, and an image data in which no person appears but which is scenically relevant to the baby. The baby's image data 16 may be accompanied by literal commentary information 19 (refer to FIG. 10). The literal commentary information 19 may include a comment, a message or any other literal information which is relevant to the corresponding baby's image data 16.

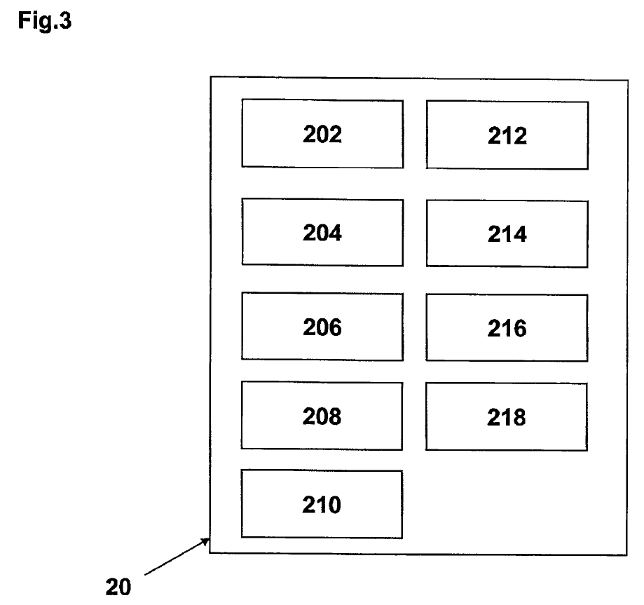

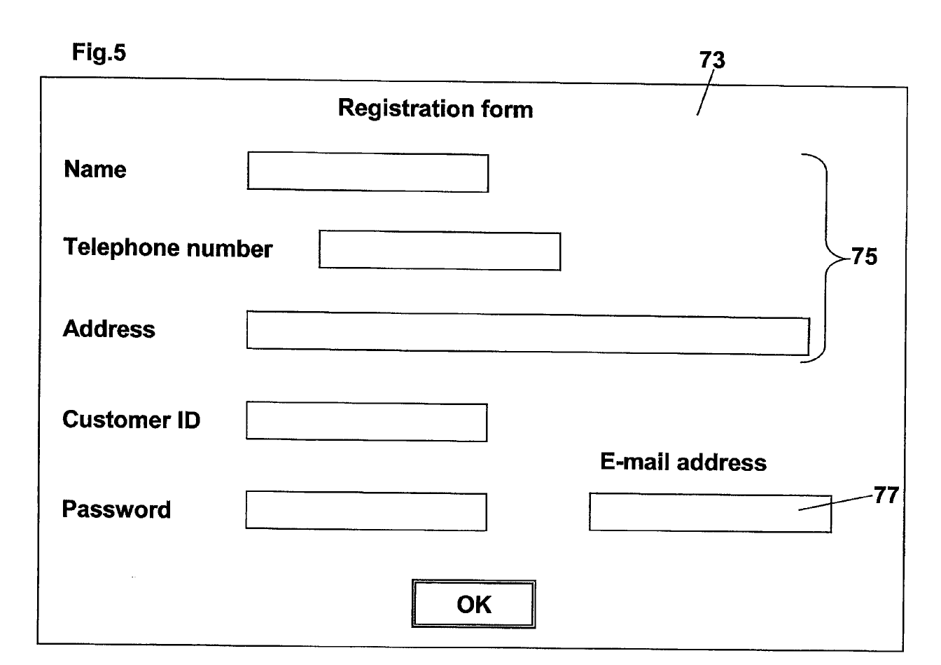

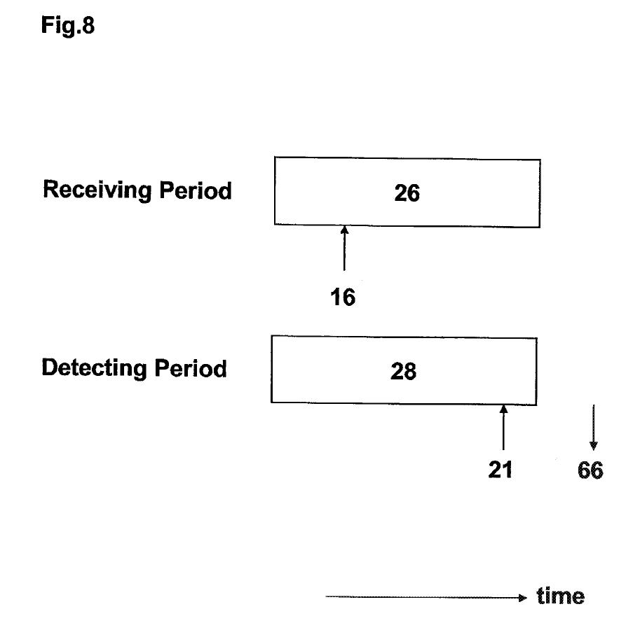

FIG. 3 illustrates a constitution of the server 20. The server 20 controls or supplies information or data to a plurality of computers connected via network 100. The server 20 receives and provides data including image data, literal data and the like; and/or a command including a print command, a data transmission command, and the like. The server 20 also provides data and/or a command to the client terminal 10 or to the print apparatus 30. The server 20 comprises a customer information receiver 202 for receiving customer information 12 (refer to FIG. 5) transmitted from the client terminal 10. The server 20 also comprises a birthday receiver 204 for receiving baby's birthday information 14 (refer to FIG. 10) transmitted from the client terminal 10. The server 20 further comprises an image receiver 206 for receiving baby's image data 16 (refer to FIG. 10). The server 20 comprises a receiving configurer 208 for configuring at least one receiving period 26 (refer to FIG. 8) based on the baby's birthday information 14. The receiving period 26 is for the server 20 to receive the baby's image data 16. The server 20 also comprises an image database 210 for storing the baby's image data 16 corresponding to the receiving period 26 for each customer. The server 20 also comprises a purchase receiver 212 for receiving a purchase record 21 of disposable baby commodities. The server 20 also comprises a detection configurer 214 for configuring a detection period 28 based on the baby's birthday information 14. The server 20 comprises a purchase detector 216 for detecting the purchase record 21 within the detection period 28. The server 20 comprises a print enabler 218 for enabling the print apparatus 30 based on the detection of the purchase record 21 within the detection period 28. The print enabler 218 enables the print apparatus 30 to print out the baby's image data 16 corresponding to the receiving period 28 for each customer after the receiving period 26 has expired.

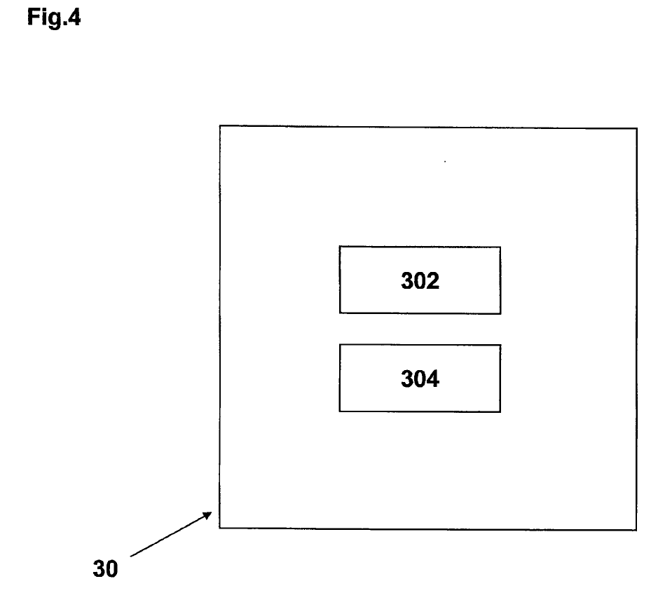

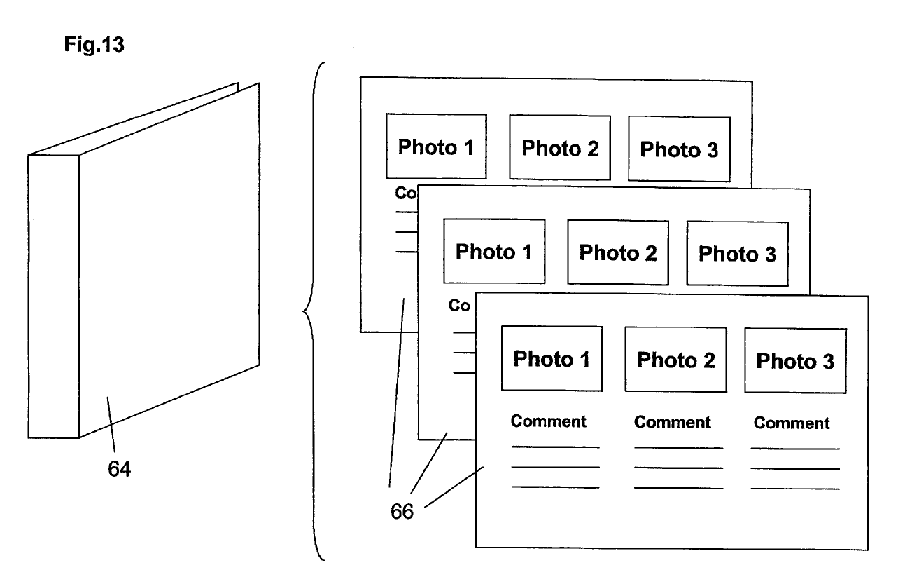

FIG. 4 illustrates a print apparatus 30. The print apparatus 30 is a device which receives data from the server 20 and prints out the data. The print apparatus 30 may include an industrial printer, a home printer, a laser printer, an inkjet printer, and the like. The print apparatus 30 comprises an image receiver 302 (refer to FIG. 10) for receiving the baby's image data 16 transmitted from the server 20 and a printer 304 for printing out the baby's image data 16 as a photo sheet 66 (refer to FIGS. 13 and 14).

The customer 8 accesses the web site of the server 20 via network 100. The customer 8 may find the URL on a package of the disposable baby commodities, on an advertisement in a newspaper, a magazine or a TV. Alternatively, the customer 8 may find the URL on the Internet, for example by a search engine such as Yahoo!®, Google® and MSN®.

FIG. 5 illustrates an example of the registration form 73 displayed on the client terminal 10 for the customer 8. In order to make the system 1 and the server 20 available, the customer 8 first registers at the server 20 via the client terminal 10. The customer 8 accesses the web site of the server 20, and enters registry information 75 into the client terminal 10. The registry information 75 may include a customer's name, age, sex, address, telephone number (e.g., home telephone number, mobile telephone phone number, facsimile number), and the like. In the embodiment of FIG. 5, a customer's name, an address and a telephone number are illustrated. The registry information 75 may further include e-mail address information 77. The e-mail address information 77 is used to deliver information such as an image data upload status, a notice from the server 20 to the customer 8 via e-mail. A receiver of the server 20 receives the registry information 75 and the e-mail address information 77, and the server 20 stores them in a customer database 13 prepared for the customer 8 (refer to FIG. 10).

When the registration of the customer 8 is completed, the server 20 may issue customer information 12 corresponding to each customer 8 and transmits the customer information 12 to the client terminal 10. Examples of the customer information 12 include a customer ID, a password and the like. The customer information 12 may be used for specifying each customer. After the customer 8 is notified of the customer information 12, the customer 8 is able to log in the server 20 with the customer information 12.

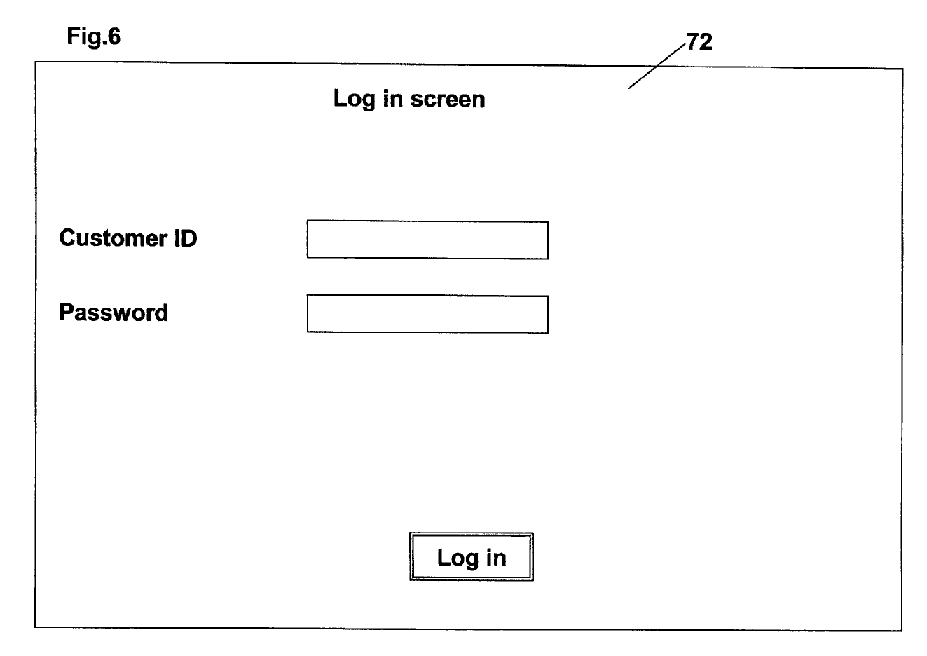

FIG. 6 illustrates an example of a login screen 72 displayed on the client terminal 10 for the customer 8. In order to upload the baby's image data 16 to the server 20, the customer 8 logs in the web site of the server 20. When the customer 8 accesses the server 20 via the client terminal 10, the server 20 transmits an input form to the client terminal 10 and the client terminal 10 displays the login screen 72. The customer 8 logs in the web site of the server 20 using the customer ID and the password. Alternatively, the customer may log in the server 20 using the e-mail address information 77 instead of the customer ID. The customer information transmitter 102 (refer to FIG. 2) of the client terminal 10 transmits the customer information 12 to the server 20. The customer information receiver 202 (refer to FIG. 3) of the server 20 receives the customer information 12. As a result, the server 20 is ready to receive the baby's image data 16 to be uploaded by the customer 8.

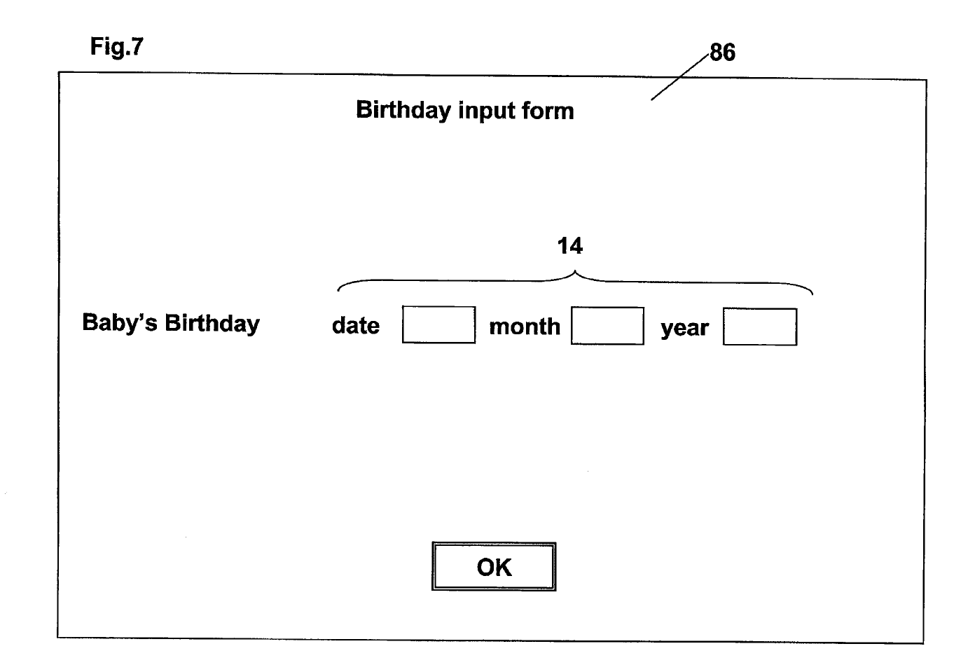

FIG. 7 illustrates a birthday input form 86 for the customer 8 to enter the baby's birthday information 14 into the server 20 via the client apparatus 10. The customer 8 enters the baby's birthday information 14 into the client terminal 10. The birthday transmitter 104 (refer to FIG. 2) of the client terminal 10 transmits the baby's birthday information 14 to the server 20 (refer to FIG. 10). The birthday receiver 204 (refer to FIG. 3) of the server 20 receives the baby's birthday information 14. The customer database 13 of the server 20 stores the baby's birthday information 14. Also, the server 20 associates the baby's birthday information 14 with the customer information 12 for each customer in the customer database 13. When the customer 8 registers at the server 20 after the baby is born, the customer 8 may enter the baby's birthday information 14 together with the registry information 75. The baby's birthday information 14 is used as the basis for configuring the receiving period 26 for the server 20 to receive the baby's image data 16 and for configuring the detection period 28 for the server 20 to detect the purchase record 21. The baby's birthday information 14 includes a date, a month and a year.

FIG. 8 illustrates a time table for configuring a receiving period 26 and a detection period 28. The receiving configurer 208 (refer to FIG. 3) of the server 20 configures at least one receiving period 26 based on the baby's birthday information 14. The detection configurer 214 (refer to FIG. 3) of the server 20 also configures a detection period 28 based on the baby's birthday information 14.

The receiving period 26 is for the server 20 to receive the baby's image data 16. When the customer 8 uploads the baby's image data 16 via the client terminal 10 within the receiving period 26, the transmitter 106 (refer to FIG. 2) of the client terminal 10 transmits the baby's image data 16 to the server 20 and the image receiver 206 (refer to FIG. 3) of the server 20 receives the baby's image data 16 within the receiving period 26. The server 20 associates the baby's image data 16 with the customer information 12 for each customer in the customer database 13 of the server 20.

The system 1 provides each customer with at least one photo sheet 66 over a service period 27. The time length of the service period 27 may be arbitrarily determined. It may be for example about one year, about two years, about three years, about four years or about five years, but it is not limited thereto. The receiving configurer 208 configures one or more of the receiving period(s) within the service period 27. For example, if each of the configured receiving periods is one month long over the service period of three years, the receiving configurer 208 may configure thirty-six receiving periods. Also for example, if the configured receiving period is three years long over the service period of three years, the receiving configurer 208 may configure only one receiving period. That is, the time length and the number of the receiving period 26 may be determined arbitrarily in relation to the service period 27. In the embodiment of FIG. 8, the receiving configurer 208 configures one receiving period 26.

The detection period 28 is for the server 20 to detect the purchase record 21 of the disposable baby commodities. When the customer 8 submits the purchase record 21, the purchase receiver 212 of the server 20 receives the purchase record 21. Then the purchase detector 216 of the server 20 detects the purchase record 21, and the print enabler 218 enables the print apparatus 30 to print out the baby's image data 16 accumulated during the receiving period and stored in the customer database 13 of the server 20. Therefore, the detection period 28 may be determined to correspond to the receiving period 26. The detection configurer 214 of the server 20 may configure the time length and the number of the detection period 28 arbitrarily in relation to the corresponding receiving period 26. For example, the receiving period 26 and the corresponding detection period 28 may be determined to have the same start date and/or end date. Or for example, the receiving period 26 and the corresponding detection period 28 may be determined to have the same time length. The time length of the detection period 28 may be configured to be longer than or shorter than that of the corresponding receiving period 26.

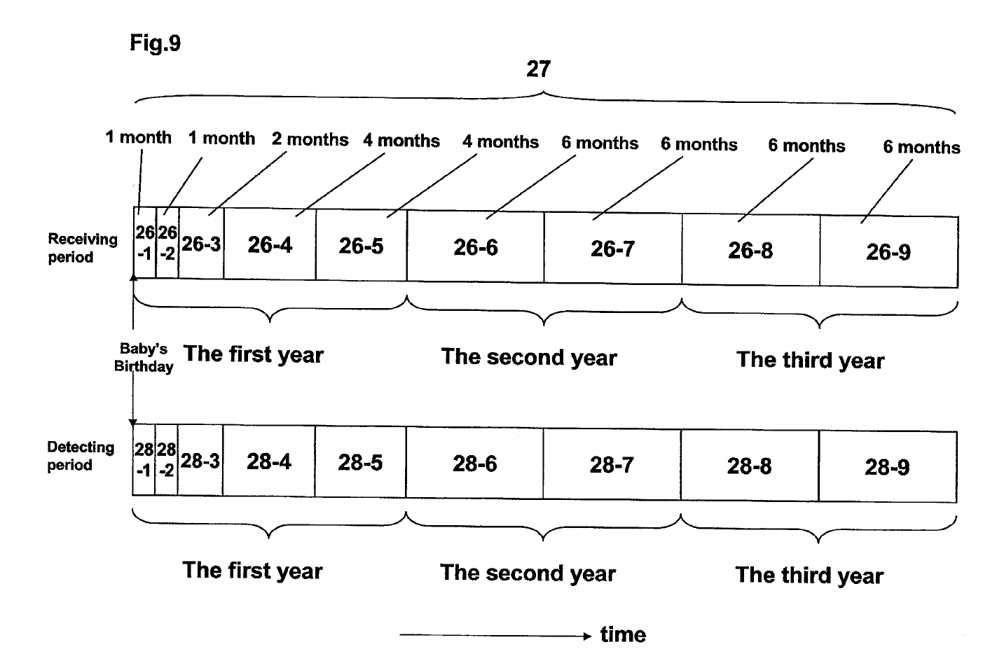

FIG. 9 illustrates a time table including a plurality of receiving periods 26 for receiving the baby's image data 16 and a plurality of detection periods 28 for detecting the purchase records 21.

In the embodiment of FIG. 9, the receiving configurer 208 configures a plurality of receiving periods 26-1, 26-2, 26-3, 26-4, 26-5, 26-6, 26-7, 26-8 and 26-9 based on the baby's birthday information 14 over a service period 27 of three years. The time length of the preceding receiving period may be equal to, longer than or shorter than that of the succeeding receiving period. When two periods are taken, the preceding period is the one that precedes the other period and the succeeding period is the one which succeeds the preceding period. As the growth speed of a child is typically faster in early stages of development than later stages, the customers may hope to store more pictures from the child's early stage of development. Therefore, the receiving configurer 208 may configure the time length of the preceding receiving period shorter than that of the succeeding receiving period. The receiving periods are configured so that the first year of the service period 27 may contain five receiving periods, the second year of the service period 27 may contain two receiving periods and the third year of the service period 27 may also contain two receiving periods. In the first year, the time length of the preceding receiving period may be equal to that of the succeeding receiving period (see 26-1 and 26-2, 26-4 and 26-5) or shorter than that of the succeeding receiving period (see 26-2 and 26-3, 26-3 and 26-4). In the second year, the time length of the preceding receiving period 26-6 is equal to that of the succeeding receiving period 26-7. Also in the third year, the time length of the preceding receiving period 26-8 is equal to that of the succeeding receiving period 26-9.

Likewise, in the embodiment of FIG. 9, the detection configurer 214 configures a plurality of detection periods 28-1, 28-2, 28-3, 28-4, 28-5, 28-6, 28-7, 28-8 and 28-9 based on the baby's birthday information 14 and in relation to the receiving periods 26-1, 26-2, 26-3, 26-4, 26-5, 26-6, 26-7, 26-8 and 26-9 respectively over a service period of three years. In the embodiment of FIG. 9, each of the detection periods has the same time length as the corresponding receiving period.

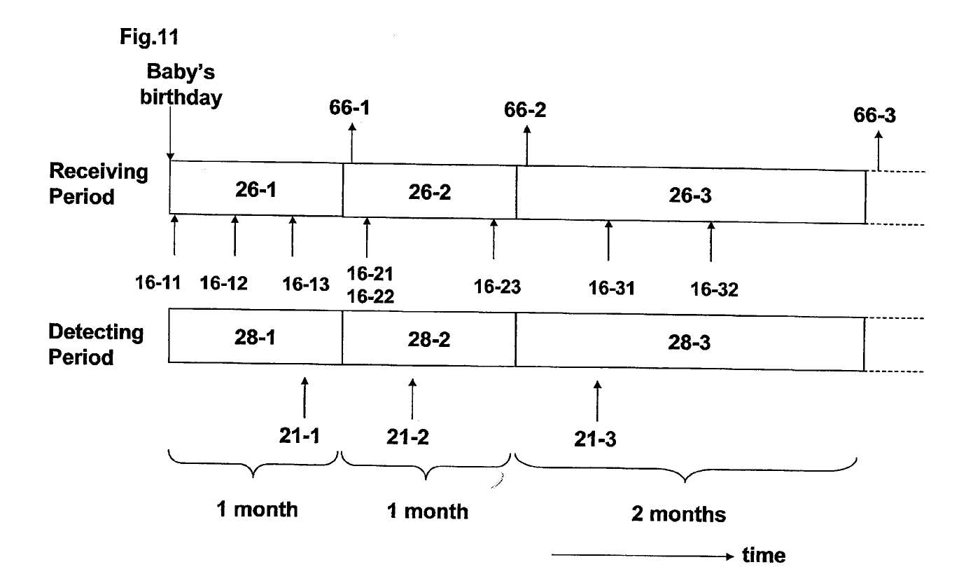

The image database 210 (refer to FIG. 3) of the server 20 is where the baby's image data 16 corresponding to the receiving period 26 for each customer 8 in the customer database 13 is stored. In certain embodiments, referring to FIG. 11, the customer 8 uploads the baby's image data 16 to the server 20 via the client terminal 10 within the receiving period 26. The customer 8 prepares the baby's image data 16 by a known method, for example, by taking a photograph of the baby with a digital camera. In certain embodiments, the digital camera may generate image data 16 of the baby that corresponds to the photograph. The customer 8 may be adapted to transfer and/or store the baby's image data 16 in storage media such as a computer, a hard disk and a flash memory. The storage media may be integrated with the client terminal 10 or may be separated from the client terminal 10. The customer 8 uploads the stored baby's image data 16 to the server 20 via the client terminal 10. Other suitable examples of generating image data include without limitation photographs with a silver salt camera and scanning a developed film or a printed sheet. If a mobile telephone and a digital camera are integrated, the customer 8 may take a photograph, store the baby's image data 16 generated based on the photograph and upload the baby's image data 16 with the mobile telephone. The customer 8 may attach literal commentary information 19 to the baby's image data 16 (refer to FIG. 10). The image transmitter 106 of the client terminal 10 transmits the baby's image data 16 and the literal commentary information 19 to the server 20 (refer to FIGS. 2 and 10). The image receiver 206 of the server 20 receives the baby's image data 16. The image receiver 206 may further receive the literal commentary information 19. The image receiver 206 may receive as many baby's image data 16 as the server 20 can accept. For example, the image receiver 206 may accommodate from one to six image data to contain the image data 16 in a single photo sheet.

The baby's image data 16 for each customer in stored in the image database 210 and corresponds to a receiving period 26. The server 20 associates the baby's image data 16 with the customer information 12. The association of the baby's image data 16 with the customer information may be done by the server 20 or by another component.

When the customer 8 submits the purchase record 21 to the server 20 (refer to FIG. 10) within the detection period 28, the purchase detector 216 (refer to FIG. 3) of the server 20 detects the purchase record 21 of the disposable baby commodities within the detection period 28. Then the print enabler 218 of the server 20 enables the print apparatus 30 to print out the baby's image data 16 corresponding to the receiving period 26 after the receiving period 26 has expired.

The purchase record 21 is a record of purchase of disposable baby commodities which is an electronic signal recognizable by the server 20. The purchase record 21 may be generated based on a purchase mark. The purchase mark is a proof of purchase which becomes available to the customer 8 for customer's exclusive use when the customer 8 purchases the disposable baby commodities. When the purchase mark is printed on the disposable baby commodities or a package thereof, the customer 8 may cut off the purchase mark and send it to the manufacturer by a commercially available delivery service such as a postal service or a home delivery service. An operator of the manufacturer may enter the purchase record 21 into the customer database 13 of the server 20 by referring to the delivered purchase mark. When the purchase mark is printed on a sheet such as a postcard enclosed in the package of the disposable baby commodities, the customer 8 may send the sheet to the manufacturer by a commercially available delivery service. The operator may enter the purchase record 21 into the customer database 13 of the server 20 as described above. Or when the purchase mark is electronically readable such as a one-dimensional code such as barcode, a two-dimensional code such as QR-code®, or a sequence of a number, the purchase record 21 may be generated based on the purchase mark using a reader or a scanner. The customer 8 may directly submit the purchase record 21 to the server 20 via network 100. The purchase mark may include a symbol such as a product identification code, a production serial number or a purchase point according to the price or the volume of the commodity; a picture such as an illustration, a drawing, etc.

For example, the customer 8 purchases disposable baby commodities and cuts off the purchase mark printed on the disposable baby commodities or the package thereof. Then the customer 8 may accumulate the purchase points of the disposable baby commodities. After the customer 8 accumulates the purchase points required by the manufacturer, the customer 8 may send the purchase marks to the manufacturer by a commercially available delivery service. Then the operator of the manufacturer may enter a purchase record 21 generated based on the purchase mark into the customer database 13 of the server 20 for each customer 8. When the purchase mark is electronically readable, the customer 8 may submit a purchase record 21 generated based on the purchase mark to the server 20 via network 100. Otherwise, the customer 8 may send the electronically readable purchase mark to the manufacturer by a commercially available delivery service, and the operator of the manufacturer may enter into the customer database 13 of the server 20 a purchase record 21 generated based on the purchase mark. The customer 8 may submit the purchase record 21 to the manufacturer indirectly. For example, when an agent takes the place of the manufacturer to receive the purchase record 21, the customer 8 submits the purchase record 21 indirectly to the server 20.

When the purchase detector 216 (refer to FIG. 3) of the server 20 detects the purchase record 21 within the detection period 28, the print enabler 218 (refer to FIG. 3) of the server 20 enables the print apparatus 30 to print out the baby's image data 16 as a photo sheet 66 after the receiving period 26 has expired. The print enabler 218 of the server 20 may include transmitting the baby's image data 16 and a print command to the print apparatus 30. The print enabler 218 may further transmit the customer information 12, the baby's birthday information 14, the literal commentary information 19 and the like.

When the customer 8 fails to submit the purchase record 21 to the server 20 within the detection period 28, the purchase detector 216 of the server 20 cannot detect the purchase record 21. Accordingly, the print enabler 218 of the server 20 does not enable the print apparatus 30 to print out the baby's image data 16. As a result, the customer 8 fails to receive a photo sheet 66. The customer 8 may try again to upload another baby's image data 16 in the succeeding receiving period and to submit the purchase record 21 to the server within the succeeding detection period 28.

In order that the print enabler 218 of the server 20 may enable the print apparatus 30 to print out the baby's image data 16, the detection of the purchase record 21 of the baby disposable commodities and the expiry of the receiving period 26 for receiving the baby image data 16 are required. Therefore, even if the purchase detector 216 of the server 20 detects the purchase record 21 and the image receiver 206 of the server 20 receives the baby's image data 16, the print enabler 218 does not enable the print apparatus 30 till the receiving period 26 expires. The phrase “after the receiving period has expired” may include “immediately after the receiving period 26 has expired” and “sometime after the receiving period 26 has expired”, e.g., one to ten days after the receiving period 26 has expired.

The print apparatus 30 comprises an image receiver 302 for receiving the baby's image data 16 from the server 20 and a printer 304 for printing out the baby's image data 16 transmitted from the server 20. When the print enabler 218 of the server 20 enables the print apparatus 30 to print out the baby's image data 16, the image receiver 302 of the print apparatus 30 receives the baby's image data 16 transmitted from the server 20 and the printer 304 prints out the baby's image data 16 corresponding to the receiving period 26 as a photo sheet 66. The printer 304 of the print apparatus 30 may further print out the literal commentary information 19, the customer information 12, the baby's birthday information 14 and the like. When the printer 304 of the print apparatus 30 finishes printing out the baby's image data 16, the print apparatus 30 may transmit print completion information to the server 20 by way of a transmitter. The server 20 may transmit print completion information to the client terminal 10 such that the print completion information is detectable by a customer 8, for example, by providing one or more visual or audio signals.

FIG. 11 illustrates an excerpt of the periods 26-1, 26-2, and 26-3 in the time table illustrated in FIG. 9 and an exemplified process of the present invention.

First, the customer 8 enters the customer information 12 into the client terminal 10 and the customer information transmitter 102 of the client terminal 10 transmits it to the server 20. The customer information receiver 202 of the server 20 receives the customer information 12 and identifies the customer 8. Based on the baby's birthday information 14 received by the birthday receiver 204, the receiving configurer 208 of the server 20 configures the receiving periods 26 for receiving the baby's image data 16 and the detection configurer 214 of the server 20 configures the detection periods 28 for detecting the purchase records 21 of the disposable baby commodities.

In the receiving period 26-1, the customer 8 uploads three baby's image data 16-11, 16-12 and 16-13 at different times within a period of one month. The image database 210 of the server 20 stores the baby's image data 16-11, 16-12 and 16-13 corresponding to the receiving period 26-1 for the customer 8 in the customer database 13. After the image receiver 206 of the server 20 receives the baby's image data 16-11, 16-12 and 16-13, the customer 8 submits the purchase record 21-1 to the server 20 within the detection period 28-1. Then the purchase receiver 212 of the server 20 receives the purchase record 21-1, and the purchase detector 216 of the server 20 detects the purchase record 21-1 within the detection period 28-1. After the receiving period 26-1 has expired, the print enabler 218 of the server 20 enables the print apparatus 30 to print out the baby's image data 16-11, 16-12 and 16-13 as a photo sheet 66-1 based on the detection of the purchase record 21-1 within the detection period 28-1.

In the receiving period 26-2, the interactional sequence is similar to that of the receiving period of 26-1. The time length of the receiving period 26-2 is one month and it is equal to that of the receiving period 26-1. The customer 8 uploads three baby's image data 16-21, 16-22 and 16-23. The customer 8 uploads two image data 16-21 and 16-22 at the same time. Later the customer 8 uploads the other baby's image data 16-23. Separately, the customer 8 submits the purchase record 21-2 to the server 20 within the detection period 28-2 after the image receiver 206 of the server 20 receives the baby's image data 16-21 and 16-22 and before it receives the baby's image data 16-23. After the receiving period 26-2 has expired, the print enabler 218 of the server 20 enables the print apparatus 30 to print out the baby's image data 16-21, 16-22 and 16-23 as a photo sheet 66-2 based on the detection of the purchase record 21-2 within the detection period 28-2.

In the receiving period 26-3, the interactional sequence is similar to those of the receiving periods 26-1 or 26-2. The time length of the receiving period 26-3 is two month and it is longer than that of the receiving period 26-2. The customer 8 can upload up to three baby's image data, but in this case, the customer 8 uploads two baby's image data 16-31 and 16-32. Separately, the customer 8 submits the purchase record 21-3 to the server 20 before the customer 8 uploads the baby's image data 16-31 and 16-32. After the receiving period 28-3 has expired, the print enabler 218 of the server 20 enables the print apparatus 30 to print out the baby's image data 16-31 and 16-32 as a photo sheet 66-3 based on the detection of the purchase record 21-3 within the detection period 28-3.

In another embodiment, when the customer 8 does not upload any baby's image data 16 within the receiving period 26 and the customer 8 submits the purchase record 21 to the server 20 within the detection period 28, the print enabler 218 may enable the print apparatus 30 to print a photo sheet 66 which comprises a background with no baby's image data, or the print enabler 218 may skip printing a photo sheet 66 for the receiving period.

When the customer 8 does not submit the purchase record 21 within the detection period 28, the print enabler 218 of the server 20 may not enable the print apparatus 30 to print out the baby's image data 16 even if the customer 8 previously uploaded the baby's image data 16 to the server 20. Alternatively, as far as the customer 8 submits the purchase record 21 to the server 20 in the following detection period, the uploaded baby's image data may be printed as a photo sheet corresponding to the following receiving period.

The print enabler 218 of the server 20 may enable the print apparatus 30 to print out the baby's image data 16 received in the first receiving period 26 regardless of the detection of the purchase record 21 in the detection period 28 in order to give an incentive to the customers. The customer 8 may get accustomed to the system of the present invention and satisfied with the printed photo sheet 66 which is delivered to the customer.

In the embodiment of FIG. 11, the receiving period 26-1 is the first receiving period for receiving the baby's image data 16-11, 16-12 and 16-13. The print enabler 218 of the server 20 may enable the print apparatus 30 to print out the baby's image data 16-11, 16-12 and 16-13 received in the first receiving period 26-1 regardless of the detection of the purchase record 21-1 in the detection period 28-1. The first receiving period may be an incentive to the customer 8. By the free first trial, the customer 8 may feel pleased to receive a photo sheet 66 comprising the baby's image data 16-11, 16-12 and 16-13 and may also feel like purchasing the manufacturer's disposable baby commodities continually.

In the embodiment of FIG. 11, the receiving period 26-2 is the second receiving period for receiving the baby's image data 16-21, 16-22 and 16-23. Likewise, the print enabler 218 of the server 20 may enable the print apparatus 30 to print out the baby's image data 16-21, 16-22 and 16-23 received in the second receiving period 26-2 regardless of the detection of the purchase record 21-2 in the detection period 28-2. The second receiving period may be also an incentive to the customer 8.

In contrast, in the receiving period 26-3 of FIG. 11, the print enabler 218 of the server 20 enables the print apparatus 30 to print out the baby's image data 16-31, 16-32 and 16-33 received in the third receiving period 26-3 and thereafter based on the detection of the purchase record 21-3 within the detection period 28-3.

With respect to the other periods described in FIG. 9, the print enabler 218 enables the print apparatus 30 to print out each of the baby's image data 16 corresponding to the receiving periods 26-4, 26-5, 26-6, 26-7, 26-8 and 26-9 after each of the corresponding receiving periods have expired and based on the detection of the purchase record 21 within each of the corresponding detection periods.

Alternatively, the print enabler 218 may enable the print apparatus 30 to print out an image data 16 corresponding to an arbitrarily selected receiving period 26 regardless of the detection of the purchase record 21. For example, in the embodiment of FIG. 9, the print enabler 218 may enable the print apparatus 30 to print out the image data corresponding to the receiving periods 26-1, 26-5, and 26-9.

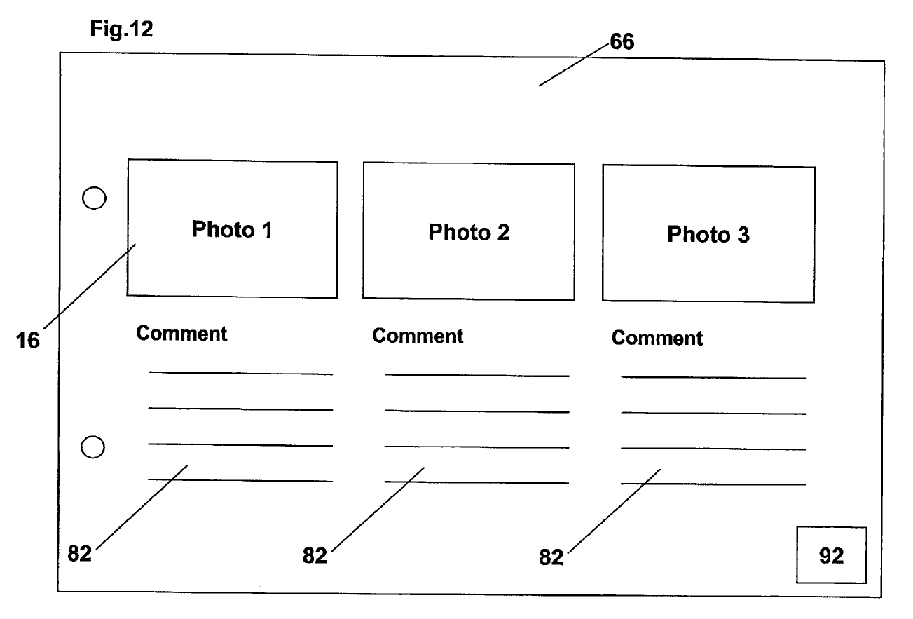

FIG. 12 illustrates an exemplary photo sheet 66 provided by the server 20 of the present invention. The photo sheet 66 includes three photographs and each photograph is provided with a comment field 82. Literal commentary information 19 may be printed on the comment field 82. The customer 8 may further handwrite a comment in the blank field after the customer 8 receives the photo sheet 66 printed with photographs. The registry information is attached as a QR-code® 92 in the lower right of the photo sheet 66, which may include the customer information 12 in order to identify the customer 8 and to deliver the photo sheet 66 to the customer 8. The number of the printed photo sheet corresponding to one receiving period is not limited to one, and for example, the print enabler 218 may enable the print apparatus 30 to print out the baby's image data 16 as a plurality of photo sheets.

The server 20 may change the background pattern, layout or other designs in the photo sheet 66 according to the sex and/or age of the baby, the customer's preference or the like. The printing may be carried out by incorporating other colors, patterns, characters, and the like in the background. The backgrounds may be uniformed in the series of the photo sheets.

The server 20 may further provide home delivery service information based on the customer information 12. The home delivery service information may include information regarding the address and the name of the customer 8 and it may be printed on a label or a photo sheet. The photo sheets 66 may be delivered to a customer 8 by any commercially available delivery means using the home delivery service information. As a result, the customer 8 may receive the photo sheet 66 of the baby's image data 16 at home.

FIG. 13 illustrates an exemplary photo book 64 comprising the photo sheets 66 prepared by the server of the present invention, each photo sheet 66 including the baby's image data 16 which corresponds to the receiving period 28. In the embodiment of FIG. 13, three photo sheets are shown. As each of the photo sheets 66 is delivered to the customer 8 sequentially, the customer 8 may file each of the photo sheets 66 in a photo book 64 respectively. The photo book 64 may be delivered to the customer 8 in advance to the delivery of the photo sheets 66. As a plurality of photo sheets 66 are accumulated, the plurality of photo sheets 66 may work as a growth record of the baby. The plurality of photo sheets 66 may also function to mark the passage of time, for example, anniversaries and/or birthdays. One or more of the plurality of photo sheets 66 may be placed in a photo album.

The server and the system of the present invention are useful for sales promotion of disposable baby commodities because the server and the system utilize the purchase record of the disposable baby commodities for providing the baby's photo sheet. The server and the system of the present invention promote the customers to purchase the disposable baby commodities by boosting the customer satisfaction.

It is understood that the examples and embodiments described herein are for illustrative purpose only and that various modifications or changes will be suggested to one skilled in the art without departing from the scope of the present invention.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A server for printing a photo sheet, the server being connected with a client terminal and print apparatus over a network, the server comprising:
(1) a first receiver configured to receive customer information,
(2) a second receiver configured to receive birthday information for a baby,
(3) a third receiver for receiving image data of a baby,
(4) a receiving configurer for configuring at least one receiving period based on the baby's birthday information, the receiving period being for receiving the baby's image data,
(5) an image database for storing the baby's image data corresponding to the receiving period for each customer,
(6) a purchase receiver for receiving a purchase record of disposable baby commodities,
(7) a detection configurer for configuring a detection period based on the baby's birthday information,
(8) a purchase detector for detecting the purchase record within the detection period and (9) a print enabler for enabling the printing apparatus, based on the detection of the purchase record within the detection period, to print out the baby's image data corresponding to the receiving period for each customer after the receiving period has expired.

2. The server of claim 1, wherein the server is used for sales promotion of disposable baby commodities.

3. The server of claim 1, wherein the baby's image data is accompanied by literal commentary information.

4. The server of claim 1, wherein at least one of the receiving configurer and the detection configurer configures two receiving periods including a preceding period and a succeeding period.

5. The server of claim 4, wherein the preceding receiving period is equal to or shorter than the succeeding receiving period.

6. The server of claim 1, wherein at least one of the receiving configurer and the detection configurer configures a plurality of periods including a first period wherein the print enabler enables the print apparatus, regardless of the detection of the purchase record, to print out the baby's image data corresponding to the first receiving period after the first receiving period has expired.

7. The server of claim 1, wherein the server provides home delivery service information based on the customer information.

8. A system for printing a photo sheet, the system comprising a server, a client terminal and a printing apparatus which are connected to one another by way of a network, wherein
(1) the client terminal comprises
(a) a first transmitter adapted to transmit customer information to the server,
(b) a second transmitter adapted to transmit a baby's birthday information to the server, and
(c) a third transmitter adapted to transmit a baby's image data to the server;
(2) the server comprises
(a) a first receiver adapted to receive the customer information,
(b) a second receiver adapted to receive the baby's birthday information,
(c) a third receiver adapted to receive the baby's image data,
(d) a receiving configurer adapted to configure at least one receiving period based on the baby's birthday information, the receiving period being for receiving the baby's image data,
(e) an image database that includes the baby's image data corresponding to the receiving period for each customer,
(f) a fourth receiver adapted to receive a purchase record of disposable baby commodities,
(g) a detection configurer that configures a detection period based on the baby's birthday information,
(h) a purchase detector that detects the purchase record within the detection period and a print enabler that enables the printing apparatus, based on the detection of the purchase record within the detection period, to print out the baby's image data corresponding to the receiving period for each customer after the receiving period has expired; and
(3) the printing apparatus comprises
(a) an image receiver that receives the baby's image data from the server and
(b) a printer that prints out the baby's image data transmitted from the server.
